(19) United States
(12) Patent Application Publication
(10) Pub. No.: US 2012/0023412 A1
(43) Pub. Date: Jan. 26, 2012

(54) System and Method for Providing Multimedia Content During an Event

(75) Inventors: Ramesh Pattabhiraman, New Albany, OH (US); Ranjan Sharma, New Albany, OH (US)

(73) Assignee: ALCATEL-LUCENT USA INC., Murray Hill, NJ (US)

(21) Appl. No.: 12/843,287

(22) Filed: Jul. 26, 2010

(51) Int. Cl. G06F 3/00

(52) U.S. Cl. 715/747

(57) ABSTRACT

A change in a status of a guest at an event is identified, and a current preference list is updated based on one or more preferences associated with the guest. Multimedia content is provided based on the updated current preference list. A set of preferences associated with the guest may be obtained by accessing a social networking web page associated with the guest.

### FIELD OF THE INVENTION

This specification relates to systems and methods for providing multimedia content, and more particularly to systems and methods for providing multimedia content adaptively during an event.

### BACKGROUND

The delivery of multimedia content, such as music and video programs, during an event, such as a party, wedding, conference, a birthday, a religious gathering, etc., can often be an important element bearing on the perceived success or failure of the event. However, existing methods for providing multimedia content during an event fail to tailor the content of multimedia programs to the preferences of the guests who are currently in attendance at the event.

### SUMMARY OF THE INVENTION

In accordance with an embodiment of the invention, a method for providing multimedia content during an event is provided. A change in a status (such as an arrival or departure) of a guest at an event is identified, and a current preference list is updated based on one or more preferences associated with the guest. Multimedia content is provided based on the updated current preference list.

In another embodiment, a set of preferences associated with the guest is obtained. For example, one or more social networking web pages associated with the guest may be accessed, and a set of preferences associated with the guest may be obtained from the social networking web page(s).

In another embodiment, an image of the guest at the event is obtained, and the identity of the guest is determined based on the image. A second image of the guest may be obtained, and the image may be compared to the second image. The second image may be obtained by accessing one or more social networking web pages associated with the guest.

In another embodiment, the current preference list comprises information relating to various topics such as multimedia programs, genres, political affiliations, etc. The set of preferences associated with the guest may comprise guest preference information indicating a multimedia program that the guest likes, a multimedia program that the guest tolerates, a multimedia program that the guest dislikes, a genre that the guest likes, a genre that the guest tolerates, and/or a genre that the guest dislikes. The current preference list may be updated by updating, based on the guest preference information, at least one likeability factor indicating how many guests like a selected multimedia program, how many guests tolerate a selected multimedia program, how many guests dislike a selected multimedia program, how many guests like a selected genre, how many guests tolerate a selected genre, and/or how many guests dislike a selected genre.

In accordance with another embodiment of the invention, an apparatus for providing multimedia content during an event is provided. The apparatus comprises means for identifying a change in a status of a guest at an event, means for updating a current preference list based on one or more preferences associated with the guest, and means for providing multimedia content based on the updated current preference list.

These and other advantages of the present disclosure will be apparent to those of ordinary skill in the art by reference to the following Detailed Description and the accompanying drawings.

### BRIEF DESCRIPTION OF THE DRAWINGS

FIG. 1 is a system for providing multimedia programs at an event, in accordance with an embodiment of the invention;

FIG. 2 is a block diagram showing components of an intelligent multimedia content manager, in accordance with an embodiment of the invention;

FIG. 3 shows a guest list, in accordance with an embodiment of the invention;

FIG. 4 is a flowchart depicting a method of providing multimedia content during an event, in accordance with an embodiment of the invention;

FIG. 5 shows a set of preferences associated with a guest, in accordance with an embodiment of the invention;

FIG. 6 shows a current preference list, in accordance with an embodiment of the invention; and

FIG. 7 shows components of a computer, in accordance with an embodiment of the invention.

### DETAILED DESCRIPTION

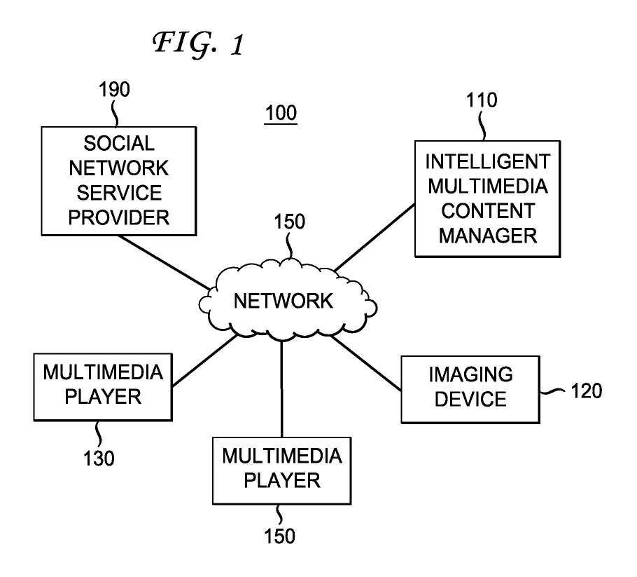

FIG. 1 is a system for providing multimedia programs at an event, in accordance with an embodiment of the invention. System 100 comprises a network 105, an intelligent multimedia content manager 110, an imaging device 120, multimedia players 130 and 150, and a social network service provider 190. While two multimedia players are shown in FIG. 1, system 100 may comprise any number of multimedia players. System 100 may also comprise more than one imaging device, and more than one social network service provider.

In the exemplary embodiment of FIG. 1, intelligent multimedia content manager 110 is linked to imaging device 120, and multimedia players 130, 150 via network 105. In other embodiments, intelligent multimedia content manager 110 may be linked to imaging device 120 and multimedia players 130, 150 by one or more direct connections.

In the exemplary embodiment of FIG. 1, network 105 comprises the Internet. In other embodiments, network 105 may comprise one or more of a number of different types of networks, such as, for example, an intranet, a home network, a wireless network, a local area network (LAN), a wide area network (WAN), an internet, Fibre Channel-based storage area network (SAN) or Ethernet. Other networks may be used. Alternatively, network 105 may comprise a combination of different types of networks.

Imaging device 120 may comprise any device capable of capturing image data, including images of individuals at an event. Imaging device 120 may capture still photographic images or video data, for example. Imaging device may also include additional capabilities, such as the ability to distinguish a person's face in an image and to focus on and/or zoom in on the face. Imaging device 120 may remain in a fixed position, or may have the capability to turn or swivel to obtain images from different angles. Imaging device 120 transmits image data to intelligent multimedia content manager 110.

In the embodiment of FIG. 1, imaging device 120 comprises a camera. Imaging device 120 may be a video camera strategically placed in the host's home during a hosted event, for example. Accordingly, imaging device 120 is sometimes referred to herein as “camera 120.” Other types of imaging devices may be used.

Multimedia players 130, 150 may be any type of device capable of delivering multimedia programs, including music and other audio programs, video programs, still photographs, etc. In the embodiment of FIG. 1, multimedia player 130 comprises a sound system capable of playing recorded music and other audio programs, and multimedia player 150 comprises a video player capable of presenting video programs. Accordingly, multimedia player 130 is sometimes referred to herein as “sound system 130,” and multimedia player 150 is sometimes referred to herein as “video player 150.” Other types of multimedia players may be used.

Sound system 130 may be a home stereo system used by a host during an event, for example. Other types of sound systems may be used. In some embodiments, sound system 130 may have access to a plurality of stored audio programs, including songs. Such audio programs may be stored in a memory (not shown) located within sound system 130, in one or more distributed memories accessible via network 105, or at another location.

Video player 150 may be a DVD player used by a host during an event, for example. Other types of video players may be used. In some embodiments, video player 150 may have access to a plurality of stored photographs and video programs, including films, video presentations, etc. Such video programs may be stored in a memory (not shown) located within video player 150, in one or more distributed memories accessible via network 105, or at another location. Video player 150 may be connected to a display device (not shown) such as a television or LCD display screen, for example.

In other embodiments, sound system 130 and video player 150 may be combined in a single system. For example, the functions of sound system 130 and video player 150 may be performed by a single audiovisual presentation system.

Intelligent multimedia content manager 110 controls the delivery of multimedia content by multimedia players 130, 150. For example, intelligent multimedia content manager 110 may cause multimedia player 130 or multimedia player 150 to play a selected multimedia program at a selected time. In one embodiment, intelligent multimedia content manager 110 may select, from among multiple CDs located in sound system 130, a desired CD and a desired song on the selected CD, and cause sound system 130 to play the selected song. Similarly, intelligent multimedia content manager 110 may select, from among multiple DVDs located in video player 150, a desired DVD and a desired video program, or a desired portion of a video program, on the selected DVD, and cause video player 150 to play the selected video program. In embodiments discussed below, intelligent multimedia content manager 110 may cause multimedia player 130 or multimedia player 150 to deliver multimedia content in accordance with a predetermined set of rules.

Social network service provider 190 maintains one or more social networking websites which are accessible via network 105 to a plurality of users. In on embodiment, a social networking website comprises one or more web pages maintained by respective individuals. An individual may store, on his or her web page, selected information including biographical information, personal preferences, images, videos, as well as information about friends and acquaintances. In the embodiment of FIG. 1, social network service provider 190 maintains a social networking website that is accessible via the Internet, such as Facebook.com, MySpace.com, etc. Use of social networking websites is known.

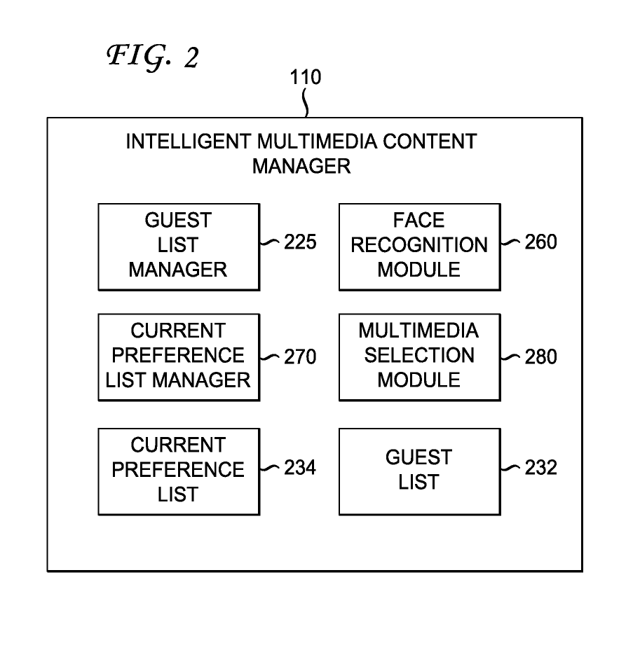

FIG. 2 is a block diagram showing functional components of intelligent multimedia content manager 110, in accordance with an embodiment of the invention. Intelligent multimedia content manager 110 comprises a guest list manager 255, a face recognition module 260, a current preference list manager 270, and a multimedia selection module 280.

Guest list manager 255 maintains a guest list 232, which contains a list of guests invited to an event. Guest list 232 may be stored in a memory or other storage device, for example. Guest list manager 255 may augment guest list 232 with additional information that is subsequently used to provide multimedia content during the event.

Face recognition module 260 receives image data from camera 120, analyzes the image data to identify a face of an individual in the image data, and determines an identity of the individual based on the image. Face recognition systems and techniques are known. Face recognition module 260 may use image data stored in guest list 232 to determine an individual's identity.

Current preference list manager 270 maintains and updates a current preference list 234, which may be stored in a memory or other storage device, for example. Current preference list 234, which is illustrated in FIG. 6 and discussed in more detail below, comprises a list of topics pertaining to various preferences that guests may have. For example, current preference list 234 may specify one or more multimedia programs such as songs, video programs, photographs, etc., and one or more genres indicating types of music, films, literature, etc. Current preference list 234 may also specify topics with respect to which guests may have preferences, such as political or religious affiliations, sports, food, smoking habits, hobbies, airplane seating arrangements, hotel accommodations, fashion-related preferences, and/or rental car selection preferences. From time to time, current preference list manager 270 may update current preference list 234 by adding a topic to, or removing a topic from, current preference list 234.

Multimedia selection module 280 manages the delivery of multimedia programs at an event based on information in current preference list 234. For example, multimedia selection module 280 may consult current preference list 234 to select a song, and cause sound system 130 to play the selected song. Multimedia selection module 280 may similarly consult current preference list 234 to select a photograph or video program, and cause video player 150 to play the selected photograph or video program.

In accordance with an embodiment of the invention, a host of a planned event invites one or more guests to the event. The event may be a party, a wedding, a conference, a birthday, a religious gathering, or other type of event. The host may utilize an online event planning website, such as eVite.com, for example, to organize the event. In one embodiment, the host generates a list of the guests' names, and stores the list in guest list 232. The host may also store information relating to various guests on the host's social networking web page maintained on a social networking website associated with social network service provider 190. The host may store on his or her social networking web page information concerning guests' preferences, images of guests, etc.

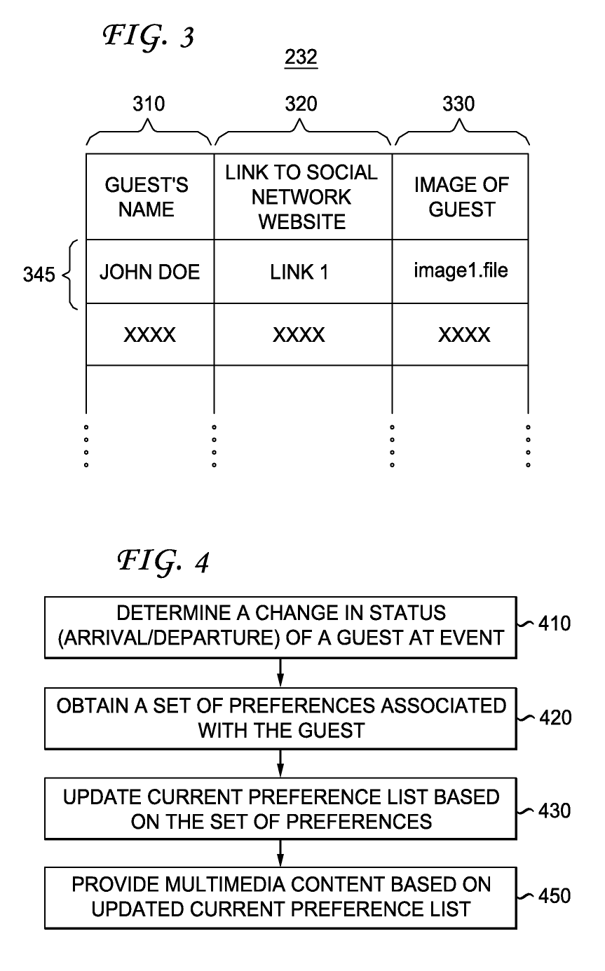

FIG. 3 shows guest list 232, in accordance with an embodiment of the invention. Guest list 232 comprises a column 310 which stores a guest's name, a column 320 which holds a link to the guest's social networking web page (which may be a web page maintained on a social networking website associated with social network service provider 190), and a column 330 for storing an image of the guest. In the exemplary embodiment, the host stores the names of the guests in column 310 of guest list. In the illustrative example of FIG. 3, the host stores the name “John Doe” in record 345. Names of other guests may also be stored in column 310. The host may populate other columns in guest list 232, or leave them empty. Alternatively, guest list manager 255 may access information stored by the host at an online event planning website, or the host's social networking web page, to obtain a list of the invited guests' names, and store the names of the guests in guest list 232.

After the names of the guests are stored in guest list 232, guest list manager 255 augments the information in guest list 232 by adding information pertinent to each guest on the list. Guest list manager 255 may be activated by the host or may execute automatically (as a background application, for example). Guest list manager 255 may identify a guest name in column 310 and obtain a link to the guest's social networking web page. A guest may maintain more than one social networking website; therefore, links to more than one social networking web pages associated with the guest may be obtained. To obtain a link to a guest's social networking web page and other information pertinent to a guest, guest list manager 255 may access the host's social networking web page and identify and examine a profile or other information relating to the guest, for example. Guest list manager 255 may also obtain from the host's social networking web page an image of the guest's face, for subsequent use by face recognition module 260 in identifying the guest. In the exemplary embodiment illustrated in FIG. 3, guest list manager 232 obtains from the host's social networking web page a link (link1) to John Doe's social networking web page, and an image file (image1.file) of John Doe, and stores the link and the image in record 345. Multiple links, and multiple images, may be stored in guest list 232. In other embodiments, guest list manager 255 may obtain information (including links and images) associated with various guests from other sources. For example, guest list manager 232 may access contact folders and/or other personal files stored by the host in memory 230. In some embodiments, the host receives in advance from various guests any authorization required to access the guests' respective social networking web pages, and any information or passwords that may be required to access those web pages.

In other embodiments, information pertaining to a guest, including a link to a social networking web page and/or an image of the guest, may be stored in other types of data structures, and/or in other locations.

In accordance with an embodiment of the invention, when a planned event takes place, an image of a guest is captured during the event, and a change in the guest's status (e.g., arrival or departure) is determined based at least in part on the image. Current preference list 234 is updated based on the guest's preferences. For example, if the guest is arriving, the guest's preferences may be added to current preference list 234. If the guest is leaving, the guest's preferences may be removed from current preference list 234. Multimedia programs are provided at the event based on the updated current preference list 234. For example, a song, video program, or still photograph may be selected from updated current preference list 234 and presented at the event.

FIG. 4 is a flowchart depicting a method of providing multimedia content during an event, in accordance with an embodiment of the invention. As discussed above, camera 120 is strategically placed to capture images of guests arriving and leaving. Camera 120 may be placed near a front door of a house, for example. At step 410, a change in the status (e.g., arrival or departure) of a guest at an event is determined. Supposing, for example, that John Doe arrives at the event, camera 120 captures an image of John Doe. Camera 120 transmits the image to intelligent multimedia content manager 110. Face recognition module 260 analyzes the image to determine an identity of the guest. For example, face recognition module 260 may compare the image to image data stored in guest list 232, to determine an identity of the guest. In this example, face recognition module 260 uses the captured image and the image stored in record 345 of guest list 232 to identify John Doe, and informs current preference list manager 270 of the change in status (in this example, the arrival) of John Doe.

At step 420, a set of preferences associated with the guest is obtained. In the present example, current preference list manager 270 accesses guest list 232 to retrieve a link to John Doe's social networking web page (from record 345). Current preference list manager 270 uses the link to access John Doe's social networking web page in order to determine a set of preferences for John Doe. Alternatively, current preference list manager 270 may access other sources, such as personal folders and/or contact lists of the host, or the host's social networking web page, to obtain preferences of the guest. In accordance with an embodiment, if no preferences are found for a respective guest, then preference information for the guest may be generated based on predetermined, generic age-appropriate preference data.

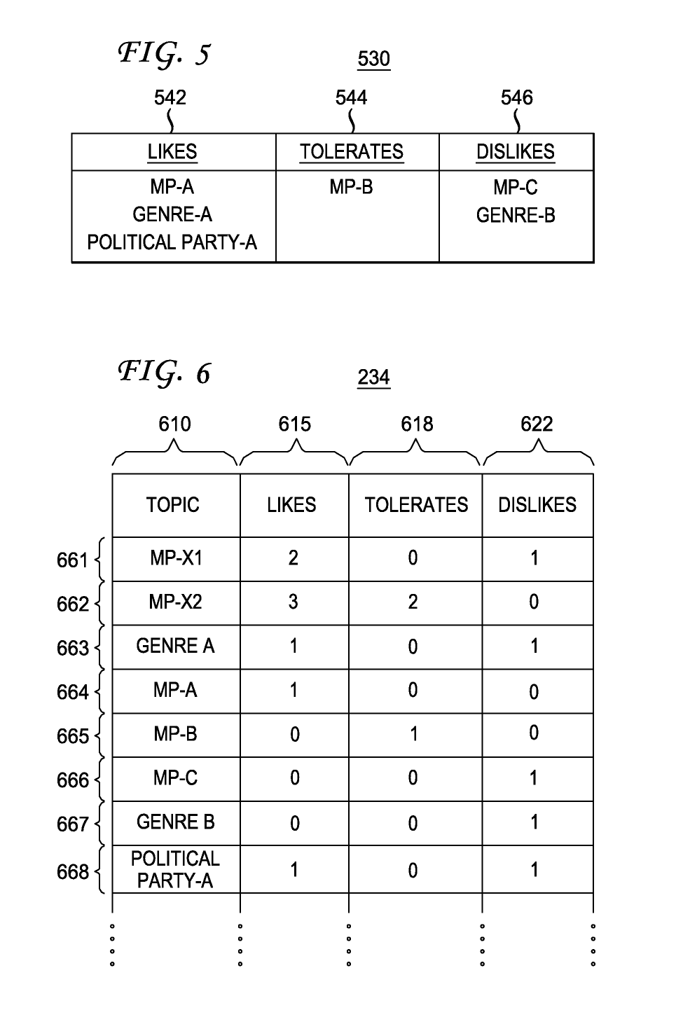

A set of preferences obtained for a guest may specify various topics, including multimedia programs and genres, and indicate which topics the guest likes, tolerates, and/or dislikes. The set of preferences may also indicate preferences regarding political or religious topics, sports, food, smoking habits, hobbies, airplane seating arrangements, hotel accommodations, fashion-related preferences, rental car selection preferences, etc. FIG. 5 shows a set of preferences 530 associated with a guest (in this example John Doe), in accordance with an embodiment of the invention. In this example, the set of preferences 530 was obtained from John Doe's social networking web page, which is maintained on a social networking website associated with social network service provider 190. Column 542 indicates that John Doe likes the multimedia program “MP-A,” the genre “Genre-A,” and political party “Political Party-A.” In this example, multimedia program MP-A may be a song, a film, or any other type of multimedia program. Similarly, the genre Genre-A may be a musical genre, a film genre, a genre of literature, or another type of genre. Political Party “Political Party A” may indicate any political party. Column 544 indicates that John Doe tolerates the multimedia program “MP-B.” Column 546 indicates that John Doe dislikes the multimedia program “MP-C” and the genre “Genre-B.”

In other embodiments, other systems and methods may be used to identify a guest, to determine a change in the status of a guest, and/or to obtain a guest's preferences. For example, a camera may be used to read the license plates of cars that are arriving at or departing from an event. The identity of guests may be determined based on the license plate numbers. Alternatively, guests may be provided an ID card containing identification information and/or information specifying their respective preferences. When a guest arrives at the event, the guest may swipe the card through or near a scanning device, which determines the guest's identity and/or preferences based on the information stored on the card.

Referring again to FIG. 4, at step 430, after a set of preferences for the guest is obtained (or generated), current preference list 234 is updated based on the set of preferences. In the present example, current preference list manager 270 updates current preference list 234 based on the set of preferences associated with John Doe. FIG. 6 shows current preference list 234, in accordance with an embodiment of the invention. In this example, current preference list 234 includes information pertaining to various topics including multimedia programs, genres, and political parties; however, in other embodiments, current preference list 234 may include information pertaining to other types of multimedia programs and other topics such as religious topics, sports, food, smoking habits, hobbies, airplane seating arrangements, hotel accommodations, fashion-related preferences, rental car selection preferences.

Current preference list 234 comprises a column 610 containing a list of topics. Prior to John Doe's arrival, column 610 lists several multimedia programs, including MP-X1 (record 661) and MP-X2 (record 662), and a genre, Genre-A (record 663). Columns 615, 618, and 618 store likeability factors indicating guests' tastes concerning the topics specified in column 610. Column 615 holds a number indicating how many of the guests currently in attendance at the event like a respective topic. Column 618 holds a number indicating how many of the guests currently in attendance at the event tolerate the topic. Column 622 holds a number indicating how many of the guests currently in attendance at the event dislike the topic. Referring to record 661, for example, two guests currently in attendance like MP-X1, no guest has indicated “tolerate” for MP-X1, and one guest has indicated a dislike for MP-X1.

While in the exemplary embodiment of FIG. 6, current preference list 234 maintains in columns 615, 618, and 622, respectively, likeability factors indicating how many guests currently present at an event like, tolerate, or dislike selected topics (including multimedia programs), in other embodiments, other types of likeability factors indicating how many guests like, tolerate, or dislike selected topics may be used to indicate the tastes of guests who are currently present at an event.

Current preference list manager 270 may also store information establishing associations between selected multimedia programs and selected genres. Such information may indicate that a particular song belongs to the “classical music” genre, or that a film belongs to the “comedy” genre. Current preference information may store such information in current preference list 234, or may store the information separately.

After John Doe's preferences are obtained, current preference list 234 is updated based on John Doe's preferences. Accordingly, current preference list 234 is updated to include records 664-668, which specify MP-A, MP-B, MP-C, Genre-B, and Political Party-A, respectively. The likeability factors in columns 615, 618, and 622 are updated based on John Doe's preferences.

In embodiments of the invention, current preference list manager 270 may update current preference list 234 in accordance with a predetermined set of rules. In an embodiment of the invention, current preference list manager 270 updates current preference list 234 in accordance with a set of rules that includes the rules described below. The set of rules described below is illustrative and is not intended to be limiting. Other rules, and other sets of rules, may be used.

When a guest arrives, the guest's preferences, and current preference list 234, are examined to determine whether any topics that the arriving guest likes are already included in current preference list 234. If a topic that the arriving guest likes is not included in current preference list, the topic is added to current preference list 234. A record is created for the topic, and a ‘1’ is placed in column 615, a ‘0’ is placed in column 618 and a ‘0’ is placed in column 622. If a topic that the arriving guest likes is already included in current preference list 234, then the number in column 615 of the relevant record is increased by one.

If a topic that the arriving guest tolerates is not included in current preference list, the topic is added to current preference list 234. A record is created for the song, and a ‘0’ is placed in column 615, a ‘1’ is placed in column 618 and a ‘0’ is placed in column 622. If a topic that the arriving guest tolerates is already included in current preference list 234, then the number in column 618 of the relevant record is increased by one.

If a topic that the arriving guest dislikes is not included in current preference list, the topic is added to current preference list 234. A record is created for the song, and a ‘0’ is placed in column 615, a ‘0’ is placed in column 618 and a ‘1’ is placed in column 622. If a topic that the arriving guest dislikes is already included in current preference list 234, then the number in column 622 of the relevant record is increased by one.

In one embodiment, if an arriving guest likes a particular genre, then all multimedia programs specified in current preference list 234 that are associated with that genre are identified. For each such multimedia program, the number in column 615 is increased by one. Similarly, if an arriving guest dislikes a particular genre, then all multimedia programs specified in current preference list 234 that are associated with that genre are identified, and for each such multimedia program, the number in column 622 is increased by one.

If at least one guest dislikes a topic (the number in column 622 is non-zero) the topic is placed on hold. In addition, if at least one guest dislikes a genre, then all multimedia programs associated with that genre are placed on hold. No multimedia content associated with a topic that is on-hold is presented at the event.

When a guest leaves the event, the guest's preferences, and current preference list 234, are examined to determine if current preference list should be updated. For each topic that the guest likes, the topic is identified in current preference list 234 and the number in column 615 is decreased by one. For each topic that the guest tolerates, the topic is identified in current preference list 234 and the number in column 618 is decreased by one. For each topic that the departing guest dislikes, the topic is identified in current preference list 234 and the number in column 622 is decreased by one. As a guest leaves the event, a topic may be removed from on-hold status if appropriate. In addition, for each genre that the departing guest likes or dislikes, multimedia programs associated with that genre may be identified and the corresponding likeability factors may be updated.

A record may be removed from current preference list 234 if the updated record contains zeros in columns 615, 618, and 622 (indicating that the topic listed in the record is not listed on the preference list of any guest currently in attendance). In on embodiment, current preference list 234 stores the host's preferences, even after an event ends.

Referring now to step 450 of FIG. 4, multimedia content is provided at the event based on updated current preference list 234. For example, multimedia selection module 280 may examine updated current preference list 234, select a multimedia program, such as a song or video, from column 610, and cause multimedia player 130 or 150 to play the selected multimedia program.

Multimedia selection module 280 may select multimedia programs in accordance with a predetermined set of rules. In an exemplary embodiment, multimedia programs listed in current preference list 234 are assigned priority scores based on how many guests currently in attendance like the multimedia program (as indicated by the number in column 615). For example, a multimedia program may be assigned one point for each guest who likes the program and zero points for each guest who tolerates the program. Multimedia programs having higher priority scores may selected before programs having lower priority scores. Multimedia selection module 280 selects multimedia programs from current preference list 234 based on their respective priority scores, and causes multimedia player 130 and/or 150 to present the selected programs.

In the exemplary embodiment, multimedia selection module 280 monitors which genres and which individual multimedia programs are currently on-hold. Multimedia programs which are on-hold are not played regardless of their priority scores. An additional rule may stipulate that a particular multimedia program may not be played more than once within a predetermined period (for example, once every three hours).

Other rules, and other sets of rules, may be used. For example, in other embodiments of the invention, multimedia programs may be selected from column 610 randomly or in a predetermined order, for example.

In other embodiments, systems and methods described herein may be used to obtain and utilize the preferences of guests in other environments. For example, systems and methods described herein may be used to seat guests in a dining room (at a conference center, hotel, etc.) in a dynamic manner. As guests arrive, their identities and preferences (including their meal preferences, smoking habits, political preferences, etc.) are obtained, and seating assignments are dynamically determined based on the guests' preferences.

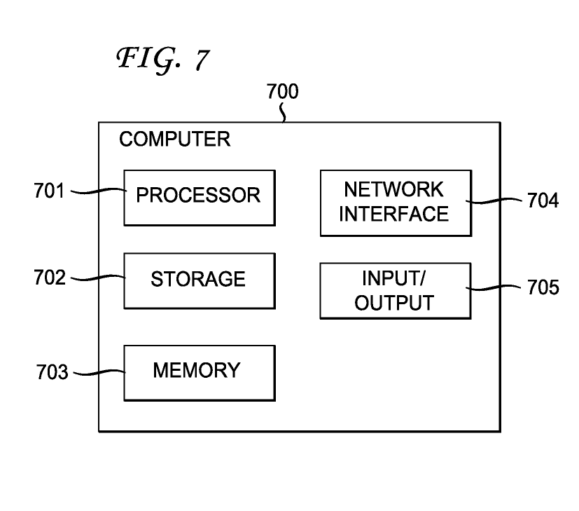

The above-described methods can be implemented on a computer using well-known computer processors, memory units, storage devices, computer software, and other components. A high-level block diagram of such a computer is illustrated in FIG. 7. Computer 700 contains a processor 701, which controls the overall operation of computer 700 by executing computer program instructions that define such operations. The computer program instructions may be stored in a storage device 702, or other computer readable medium (e.g., magnetic disk, CD ROM, etc.), and loaded into memory 703 when execution of the computer program instructions is desired. Thus, the method steps of FIG. 4 can be defined by the computer program instructions stored in the memory 703 and/or storage 702 and controlled by the processor 701 executing the computer program instructions. For example, the computer program instructions can be implemented as computer executable code programmed by one skilled in the art to perform an algorithm defined by the method steps of FIG. 4. Accordingly, by executing the computer program instructions, the processor 701 executes an algorithm defined by the method steps of FIG. 4. Computer 700 also includes one or more network interfaces 704 for communicating with other devices via a network. Computer 700 also includes one or more input/output devices 705 that enable user interaction with computer 700 (e.g., display, keyboard, mouse, speakers, buttons, etc.). One skilled in the art will recognize that an implementation of an actual computer could contain other components as well, and that FIG. 7 is a high level representation of some of the components of such a computer for illustrative purposes.

In one example, intelligent multimedia content manager 110 may reside and operate on a computer at the location where an event takes places. Alternatively, intelligent multimedia content manager 110 may reside and operate on a computer, such as a server, located remotely from the event. For example, intelligent multimedia content manager 110 may reside and operate on a server that is accessed via the Internet.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for providing multimedia content during an event, the method comprising:
identifying, by a processor, a change in a status of a guest at an event;
updating a current preference list based on one or more preferences associated with the guest; and
providing multimedia content based on the updated current preference list.

2. The method of claim 1, further comprising:
obtaining a set of preferences associated with the guest.

3. The method of claim 2, comprising:
accessing a social networking web page associated with the guest; and
obtaining the set of preferences associated with the guest from the social networking web page.

4. The method of claim 1, wherein the step of identifying a change in a status of a guest comprises:
obtaining an image of the guest at the event; and
determining, by the processor, an identity of the guest based on the image.

5. The method of claim 4, further comprising:
obtaining a second image of the guest;
wherein the step of determining the identity of the guest comprises:
comparing the image to the second image.

6. The method of claim 5, wherein the step of obtaining a second image of the guest comprises:
accessing a social networking web page associated with the guest.

7. The method of claim 1, wherein the current preference list comprises information relating to at least one of: a multimedia program, a genre, a political affiliation, a religious topic, a sport, a food, a smoking habit, a hobby, an airplane seating arrangement, a hotel accommodation, a fashion, and a selection of a rental car.

8. The method of claim 7, wherein the set of preferences associated with the guest comprises guest preference information indicating at least one of: a multimedia program that the guest likes, a multimedia program that the guest tolerates, a multimedia program that the guest dislikes, a genre that the guest likes, a genre that the guest tolerates, and a genre that the guest dislikes;
wherein the step of updating a current preference list based on the set of preferences comprises:
updating, based on the guest preference information, at least one likeability factor indicating at least one of: how many guests like a selected multimedia program, how many guests tolerate a selected multimedia program, how many guests dislike a selected multimedia program, how many guests like a selected genre, how many guests tolerate a selected genre, and how many guests dislike a selected genre.

9. The method of claim 1, wherein the multimedia content comprises at least one of: a song, a video program, and a photograph.

10. An apparatus for providing multimedia content during an event, the apparatus comprising:
means for identifying a change in a status of a guest at an event;
means for updating a current preference list based on one or more preferences associated with the guest; and
means for providing multimedia content based on the updated current preference list.

11. The apparatus of claim 10, further comprising:
means for obtaining a set of preferences associated with the guest.

12. The apparatus of claim 11, comprising:
means for accessing a social networking web page associated with the guest; and
means for obtaining the set of preferences associated with the guest from the social networking web page.

13. The apparatus of claim 10, wherein the means for identifying a change in a status of a guest comprises:
means for obtaining an image of the guest at the event; and
means for determining, by the processor, an identity of the guest based on the image.

14. The apparatus of claim 13, further comprising:
means for obtaining a second image of the guest; and
means for comparing the image to the second image.

15. The apparatus of claim 14, wherein the means for obtaining a second image of the guest comprises:
means for accessing a social networking web page associated with the guest.

16. The apparatus of claim 10, wherein the current preference list comprises information relating to at least one of: a multimedia program, a genre, a political affiliation, a religious topic, a sport, a food, a smoking habit, a hobby, an airplane seating arrangement, a hotel accommodation, a fashion, and a selection of a rental car.

17. The apparatus of claim 16, wherein the set of preferences associated with the guest comprises guest preference information indicating at least one of: a multimedia program that the guest likes, a multimedia program that the guest tolerates, a multimedia program that the guest dislikes, a genre that the guest likes, a genre that the guest tolerates, and a genre that the guest dislikes;
wherein the means for updating a current preference list based on the set of preferences comprises:
means for updating, based on the guest preference information, at least one likeability factor indicating at least one of: how many guests like a selected multimedia program, how many guests tolerate a selected multimedia program, how many guests dislike a selected multimedia program, how many guests like a selected genre, how many guests tolerate a selected genre, and how many guests dislike a selected genre.

18. The apparatus of claim 10, wherein the multimedia content comprises at least one of: a song, a video program, and a photograph.
